(19) United States
(12) Patent Application Publication
(10) Pub. No.: US 2022/0237625 A1
(43) Pub. Date: Jul. 28, 2022

(54) SYSTEM AND METHOD FOR COMMUNICATING BETWEEN A VEHICULAR SERVICE PROVIDER TERMINAL ASSOCIATED WITH A VEHICULAR SERVICE PROVIDER, A VEHICULAR SERVICE CUSTOMER TERMINAL ASSOCIATED WITH A VEHICULAR SERVICE CUSTOMER, AND A VEHICLE COMMUNICATION TERMINAL ASSOCIATED WITH A VEHICLE

(71) Applicant: ZF Friedrichshafen AG, Friedrichshafen (DE)

(72) Inventors: Grigory Yezersky, Farmington Hills, MI (US); Gahl Berkooz, Ann Arbor, MI (US)

(73) Assignee: ZF Friedrichshafen AG, Friedrichshafen (DE)

(21) Appl. No.: 17/156,305

(22) Filed: Jan. 22, 2021

(51) Int. Cl. G06Q 30/00; G07C 5/00; G07C 5/08; G06Q 20/08; G06Q 30/02

(52) U.S. Cl. CPC G06Q 30/016; G07C 5/008; G06Q 30/0281; G06Q 20/0855; G07C 5/0841

(57) ABSTRACT

A vehicular service provider terminal transmits to a vehicular service customer terminal initial vehicular service conditions, receives from the customer terminal a request to change an existing vehicular service parameter and/or add a new one, transmits to the customer terminal updated vehicular service conditions taking into account the changed or added service parameter, and receives from the customer terminal a notification of accepting the updated vehicular service conditions. A parameter monitoring unit in communication with a vehicle communication terminal monitors the existing and/or new service parameter to generate vehicular service parameter data. The vehicle communication terminal transmits to the service provider terminal and/or to the customer terminal the generated vehicular service parameter data.

### BACKGROUND

### Field

This application generally relates to provision of vehicular services. In particular, this application describes a system and method for communicating between a vehicular service provider terminal associated with a vehicular service provider, a vehicular service customer terminal associated with a vehicular service customer, and a vehicle communication terminal associated with a vehicle.

### Description of Related Art

Along with electrification and intellectualization of the vehicles, the complexity of vehicular services demanded by potential customers grows drastically. This creates multiple service scenarios for the customers who may be requesting more customization resulting in including further features while rejecting other. In the future, this development may lead to the “pay for comfort” service transactions where a customer may pay a base rate for a drive and be required to pay additionally for environmental comfort. Or, a vehicular service provider may offer an incentive to a customer to reduce comfort, thereby spearing charging of the vehicle which avoids an inefficient charging action. Or, a customer may ask for a lower price under the condition that they will not turn the air conditioning on despite summer weather.

Presently, the experience of service customers related to use of a vehicle is predetermined by an initial service package/plan. Cases may arise where customers are willing to change the conditions previously agreed on. However, the vehicle structure as well as the overall service structure of today do not allow for such customization. This has overall negative impacts on the quality of the delivered vehicular services.

### BRIEF SUMMARY

A method is provided for communicating between a vehicular service provider terminal associated with a vehicular service provider, a vehicular service customer terminal associated with a vehicular service customer, and a vehicle communication terminal associated with a vehicle. The method comprises transmitting, by the vehicular service provider terminal and to the vehicular service customer terminal, a set of initial vehicular service conditions. The method further comprises receiving, by the vehicular service provider terminal and from the vehicular service customer terminal, a request to change an existing vehicular service parameter and/or to add a new vehicular service parameter. The method further comprises transmitting, by the vehicular service provider terminal and to the vehicular service customer terminal, a set of updated vehicular service conditions taking into account the changed or added vehicular service parameter. The method further comprises receiving, by the vehicular service provider terminal and from the vehicular service customer terminal, a notification of accepting the set of updated vehicular service conditions by the vehicular service customer. The method further comprises monitoring, by a parameter monitoring unit in communication with the vehicle communication terminal, the existing and/or new vehicular service parameter in order to generate vehicular service parameter data. The method further comprises transmitting, by the vehicle communication terminal and to the vehicular service provider terminal, the generated vehicular service parameter data.

### BRIEF DESCRIPTION OF THE DRAWINGS

FIG. 1 illustrates an exemplary environment that facilitates changing a vehicular service preference;

FIG. 2 illustrates an exemplary schematic diagram of various hardware components that may be included in one or more terminals of the environment to facilitate interactions with a decentralized database;

FIG. 3 illustrates exemplary operations that may be implemented by a terminal;

FIG. 4 illustrates further exemplary operations that may be implemented by a terminal;

FIG. 5 illustrates further exemplary operations that may be implemented by a terminal;

FIG. 6 illustrates further exemplary operations that may be implemented by a terminal;

FIG. 7 illustrates further exemplary operations that may be implemented by a terminal; and

FIG. 8 illustrates an exemplary computer system that may form part of or implement the terminals described in the figures or in the following paragraphs.

### DETAILED DESCRIPTION

The embodiments described below overcome the problems discussed above by providing a system and a method which enables vehicular services to be provided in a flexible and secure manner. Vehicular service customers are provided with the possibility to request to change an existing vehicular service parameter and/or to add a new vehicular service parameter. In this way, the vehicular service customers are facilitated in achieving vehicular services that best suit their actual needs. The vehicular services are hence more customized so that the service quality is enhanced.

Based on monitoring the vehicular service parameter(s), both the vehicular service providers and the vehicular service customers are given the measure to ensure that the vehicular service is performed by the vehicular service providers and utilized by the vehicular service customers in accordance with the service conditions agreed on by both sides. On the one hand, the vehicular service customer can determine based on the vehicular service parameter data acquired from the monitoring process whether the vehicular service is being or has been provided properly. This information can be used in order to claim reimbursement of service fees that have been charged without ground. On the other hand, the vehicular service provider can determine based on the vehicular service parameter data whether the vehicular service is being or has been utilized properly by the vehicular service customer. This information can be used in order to claim further payment of service fees that have not been charged for additional service features utilized by the vehicular service customer. In this way, the level of satisfaction with regard to the provision of vehicular services is increased for both the vehicular service providers and the vehicular service customers.

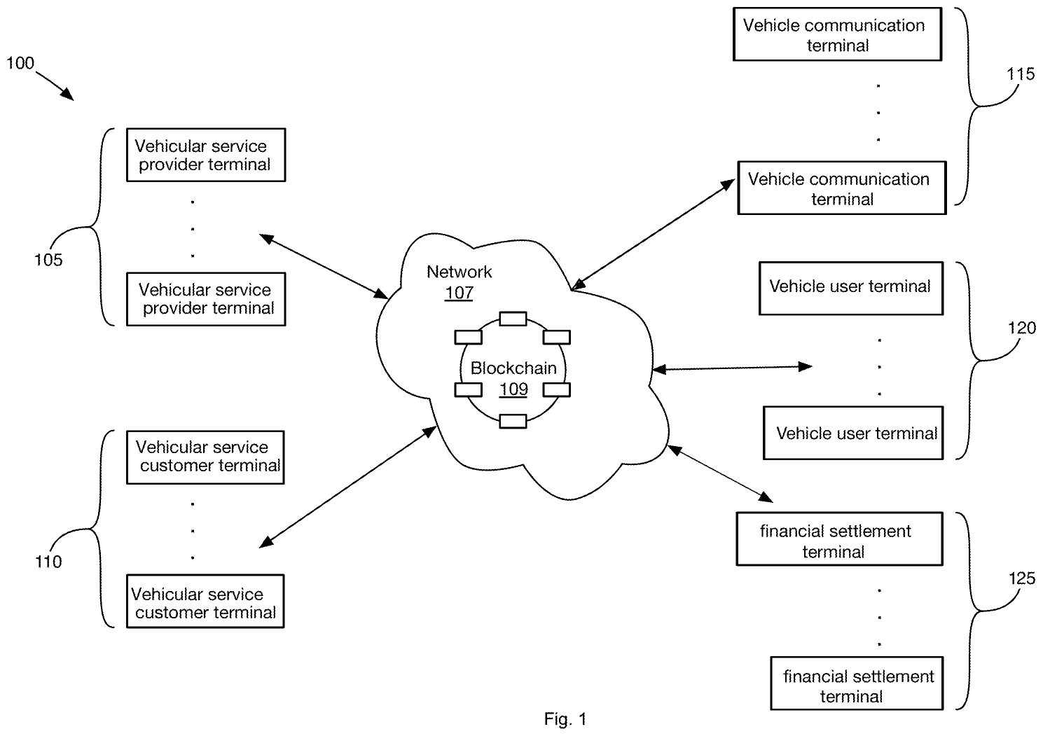

FIG. 1 illustrates an exemplary environment 100 that facilitates vehicular services to be provided in a flexible and secure manner. Illustrated in the environment 100 are entities that include vehicular service provider terminals 105, vehicular service customer terminals 110, vehicle communication terminals 115, vehicular service user terminals 120, and financial settlement terminals 125.

In the auto industry context, the vehicular service provider terminals 105 may be servers, computer systems or devices operated by automotive companies including OEMs, component suppliers (e.g., tier 1 suppliers) and providers of mobility services such as car sharing, car renting, car infotainment services, car hailing and the like. Within the scope of the present invention, such entities are regarded as vehicular service providers which the vehicular service provider terminals 105 are associated with.

The vehicular service customer terminals 110 may correspond to computer systems or devices (e.g., mobile devices) of customers of the vehicular service providers (vehicular service customers). The vehicular service customers may be registered in a database of the vehicular service providers that links registered customers (including their contact information) to individual vehicular services. More than one vehicular service customer may be registered to a particular vehicular service in various embodiments.

The vehicle communication terminals 115 may correspond to computer systems of vehicles including a data interface for data exchange. The vehicles may be operated by end users or fleet provider companies. That is, the vehicle may be operated by both end users and companies that operate a fleet of vehicles (e.g. to provide mobility as a service). The vehicle communication terminals 115 may comprise a control-area-network (CAN), in particular a CAN Bus, and/or a wireless network, in particular a nearfield communication (NFC) network based on infrared (IR) or Bluetooth. The vehicles may be cars, plains, trains, ships, etc.

The vehicular service user terminals 120 may correspond to computer systems or devices (e.g., mobile devices) of users of vehicular services (vehicular service users). In various embodiments, the vehicular service users may be the same person as the vehicular service customers (e.g. both being the user/owner of a vehicle). In other embodiments, the vehicular service users may be a different person from the vehicular service customers (e.g., vehicular service user being a child of the vehicular service customer who may be the user/owner of a vehicle where the vehicular services are performed).

The financial settlement terminals 125 may correspond to computer systems or devices (e.g., mobile devices) of entities specialized in financial settlements (financial settlement entities) such as an independent third-party (e.g., mediators, arbitrators or consulting agencies) determined as the party responsible for resolving any financial disputes and reaching an agreement between the vehicular service provider and the vehicular service customer according to their contract.

As described in more detail below, one or more of the terminals (105, 110, 115, 120, and 125) may include various hardware components that facilitate interactions and communications with one another, for example, via a wired or wireless network 107 (e.g., the Internet). In certain examples, the vehicular service provider terminals 105 comprise servers or devices, which may communicate with one or more of the vehicle service customer terminals 110 (e.g., servers or devices), the vehicle communication terminals 115 (e.g., vehicle computer systems), the vehicular service user terminals 120 (e.g., computers or devices), and/or the financial settlement terminals 125 (e.g., servers or devices), and vice versa. Further, one or more of the terminals (105, 110, 115, 120, and 125) may include an ability to interact with a decentralized database 109 such as a blockchain decentralized database.

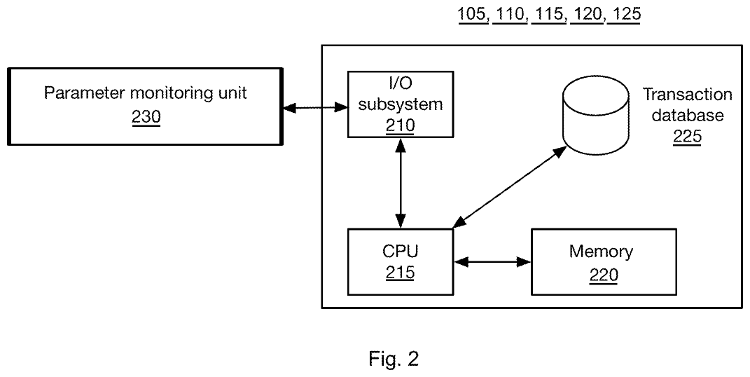

FIG. 2 illustrates an exemplary schematic diagram of various hardware components that may be included in the terminals (105, 110, 115, 120, and 125) to facilitate interactions with other terminals and/or the decentralized database. Referring to the diagrams, each terminal may include one or more central processing units (CPU) 215 or other processing devices, input/output (I/O) subsystems 210, and memories 220.

The I/O subsystem 210 of each terminal (105, 110, 115, 120, and 125) facilitates communications with other terminals (105, 110, 115, 120, and 125) of the environment 100. In this regard, the I/O subsystem 210 may implement an API such as a SOAP-based web services API to facilitate communicating information to the other terminals (105, 110, 115, 120, and 125). Other APIs, such as a RESTful API, may be implemented to facilitate communications between terminals (105, 110, 115, 120, and 125). Additionally, the terminals (105, 110, 115, 120, and 125) may implement other traditional forms of communication with other terminals (105, 110, 115, 120, and 125), such as email messages, text or SMS messages, and/or phone calls. For example, the vehicular service provider terminals 105 may be able to communicate with the vehicular service customer terminals 110, the vehicle communication terminals 115, the vehicular service user terminals 120 and the financial settlement terminals 125 via any of these known communication mediums. Additionally, in other examples, the vehicular service customer terminals 110, the vehicle communication terminals 115, the vehicular service user terminals 120 and/or the financial settlement terminals 125 may execute and implement certain applications, for example, proprietary applications of the vehicular service providers such as OEMs or mobility service providers. The vehicular service customer terminals 110 may be able to send messages via such proprietary applications to the vehicular service provider terminals 105, the vehicular service user terminals 120 and/or the financial settlement terminals 125 and vice versa.

The I/O subsystem 210 of each terminal may be configured to dynamically determine the communication methodology utilized by other terminals (105, 110, 115, 120, and 125) of the environment 100 and to communicate information to the other terminals (105, 110, 115, 120, and 125) using the determined communication methodology. For example, the I/O subsystem 210 may determine that a first terminal utilizes a RESTful API and may, therefore, communicate with the terminal using a RESTful communication methodology.

The I/O subsystem 210 may implement a web browser to facilitate generating one or more web-based interfaces or screenshots that facilitate user interactions with the respective terminals (105, 110, 115, 120, and 125). In this regard, web services may be implemented to facilitate automating some of the web-based functionality via a computer. For example, the vehicular service provider terminals 105, which may comprise one or more servers, may provide such web-based interfaces that facilitate user interactions through the vehicular service customer terminals 110 and/or the vehicular communication terminals 115.

The CPU 225 executes instruction code stored in a memory 220 for coordinating activities performed between the various subsystems. The CPU 225 may correspond to an Intel®, AMD®, ARM® based CPU or a different CPU. The CPU may perform instructions according to an operating system such as Linux or a different operating system.

In various embodiments, one or more of the terminals (105, 110, 115, 120, and 125) may include a transaction database 225. The transaction database 225 is configured to hold records about possible business transactions between the different parties the terminals (105, 110, 115, 120, and 125) are associated with. In particular, sets of initial vehicular service conditions exchanged between or agreed on by the vehicular service providers and the vehicular service customers can be held in the transaction database 225 of the vehicular service provider terminals 105 and the vehicular service customer terminals 105.

In various embodiments, the vehicle communication terminals 115 may also include or cooperate with a parameter monitoring unit 230. That is, the parameter monitoring unit 230 is in communication with the respective vehicle communication terminals 115. The parameter monitoring unit 230 may comprise a temperature sensor for monitoring the temperature controlled by an air conditioning (AC) integrated in the vehicle. The Parameter monitoring unit 230 may comprise a bandwidth measurement unit which determines the bandwidth of a vehicle wireless connection which enables the user of the vehicle to establish an internet connection with the world-wide-web or an intranet connection with a local network.

In various embodiments, records in the memory 220 and the transaction database 225 of each terminal may be replicated with one another and collectively form a decentralized database that may correspond to a block-chain database 109. In this regard, the block-chain database 109 may be utilized as a way to construct consensus around the validity of transactions, and to ensure that all changes are auditable. Stated differently, the blockchain database corresponds to a record of consensus with a cryptographic audit trail that is maintained and validated by each system. Block chains of the block-chain database act as a way to record the order of, and validate the transactions in, the block-chain database. As will be described below, the block chains further facilitate value transfer between the parties—without the usual requirement for a trusted third party. Moreover, such a database facilitates the implementation of smart contracts (e.g. for business rules) that automate processes on such a database (e.g. for defining & delivering incentives to different parties in the supply chain).

It is contemplated that any of the systems described above and/or any subsystem thereof may correspond to a stand-alone computer system such as an Intel®, AMD®, or PowerPC® based computer system or a different computer system and can include application specific computer systems. The computer systems may include an operating system, such as Microsoft Windows®, Linux, Unix® or other operating system. It is also contemplated that operations performed on the various subsystems may be combined into a fewer or greater number of subsystems to facilitate speed scaling, cost reductions, etc.

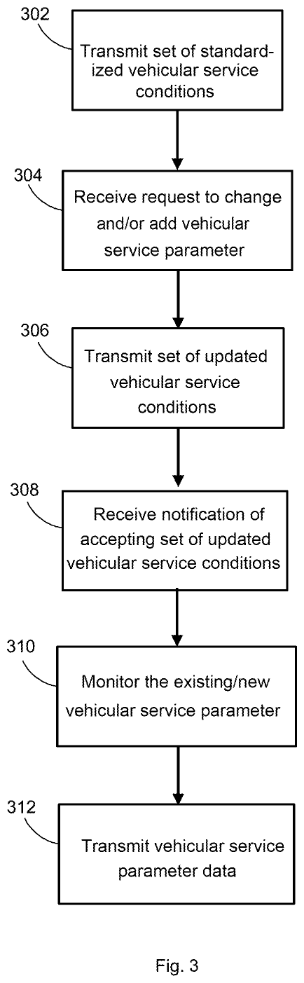

FIG. 3 illustrates exemplary operations that may be performed by the system, and in a particular example, by the vehicular service provider terminals 105, e.g., the OEM servers, the component supplier servers or the mobility service provider servers. In various embodiments, at 302, the vehicular service provider terminal 105 transmits, through its I/O subsystem 210 and via the network 107, in particular the distributed database system 109 such as blockchain, a set of initial vehicular service conditions of the vehicular service provider to the vehicular service customer terminal 110. The vehicular service customer terminal 110 receives, through its I/O subsystem 210 and via the network 107, the set of initial vehicular service conditions which contain a plurality of vehicular service parameters.

The vehicular service customer may agree with parts of the initial vehicular service conditions and disagree with other parts of them. In this case, the vehicular service customer may request to change an existing vehicular service parameter and/or to add a new vehicular service parameter into the vehicular service conditions. Within the scope of the present invention, changing a vehicular service parameter means changing a customer/user preference with regard to a value or setting of the vehicular service parameter. The change as requested may be based on a condition. For example, the vehicular service parameter may be relating to usage of the air conditioning, wherein the vehicular service customer may request to change this parameter from “turned-off” to “turned-on when the temperature outside the vehicle reaches a predefined level”. Within the scope of the present invention, the vehicular service parameter may relate to a variety of services that can be provided to an owner/user of the vehicle, including but not limited to infotainments, comfort, safety, navigation, wireless connections and the like. The change as requested may be periodic in time. Within the scope of the present invention, adding a new vehicular service parameter means introducing the vehicular service parameter that previously was not contained in the vehicular service conditions. The vehicular service customer may then initiate sending the request to the vehicular service provider. At 304, the vehicular service provider terminal 105 receives, through its I/O subsystem 210 and via the network 107, the request from the vehicular service customer terminal 110 to change an existing vehicular service parameter and/or to add a new vehicular service parameter. At this point, the provision of vehicular services has not yet taken place. That is, the process of service adjustment starts before the service has begun to be carried out.

After receiving the change request from the vehicular service customer, the vehicular service provider may issue an updated version of vehicular service conditions which take into account the changed existing vehicular service parameter and/or the added new vehicular service parameter as requested by the vehicular service customer. At 306, the vehicular service provider terminal 105 transmits a set of updated vehicular service conditions to the vehicular service customer terminal 110.

The vehicular service customer terminal 110 receives the transmitted set of updated vehicular service conditions, so that the vehicular service customer is able to provide a notification of accepting the updated vehicular service conditions. At 308, the vehicular service provider terminal 105 receives the notification of accepting the updated vehicular service conditions from the vehicular service customer terminal 110.

After completion of step 308, both sides—the vehicular service provider and the vehicular service customer—have reached an agreement over the updated vehicular service conditions taking into account the changed existing vehicular service parameter and/or the added new vehicular service parameter as requested by the vehicular service customer. The provision and usage of the vehicular services with regard to the changed and/or added vehicular service parameter can be periodically or continuously monitored so as to ensure that such vehicular services are performed and utilized in a proper manner. Also, this measure can provide grounds and factual basis for possible financial settlement processes involving the vehicular service provider and the vehicular service customer.

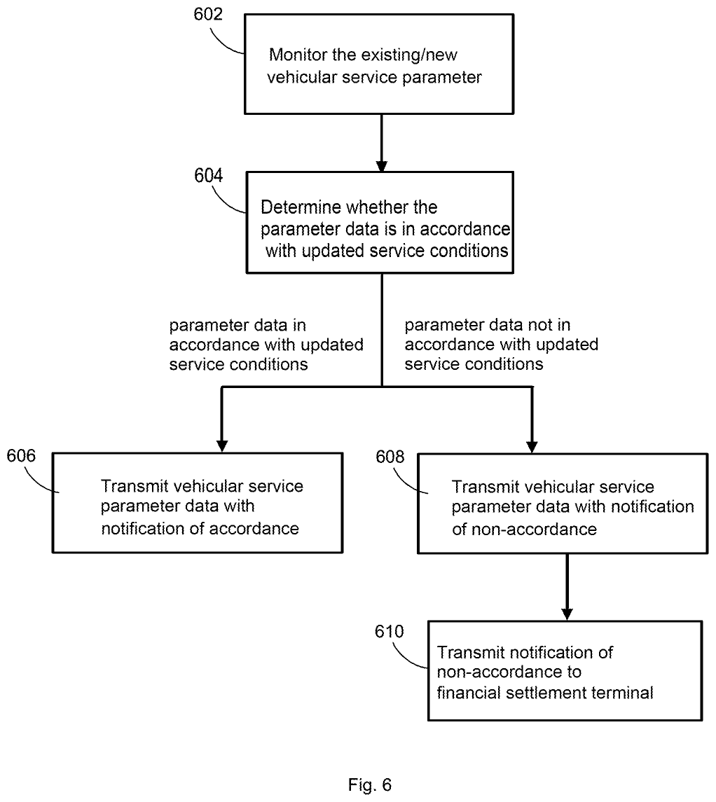

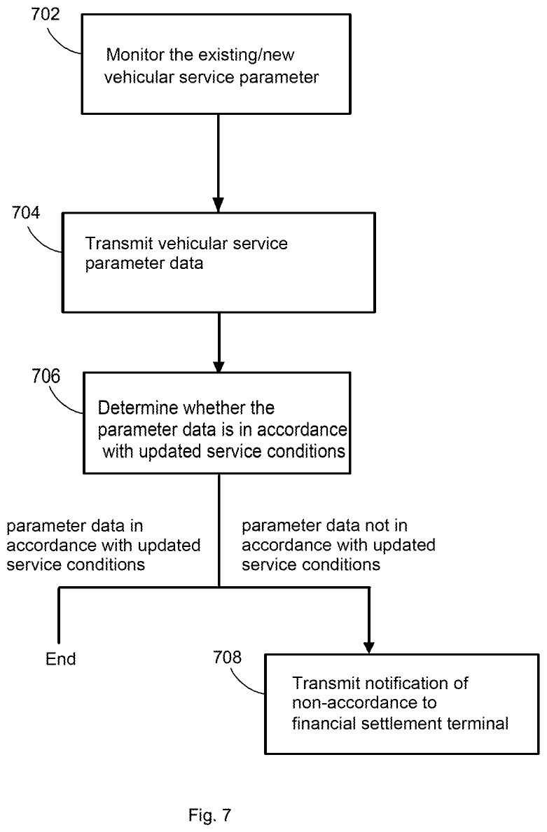

For this purpose, at 310, the existing vehicular service parameter that has been changed and/or the new vehicular service parameter that has been added as requested by the vehicular service customer is monitored by the parameter monitoring unit 230 shown in FIG. 2. The data generated by this monitoring process (vehicular service parameter data) can be stored in the memory of the vehicle communication terminal 115, which may be an electronic control unit (ECU), preferably an airbag control unit (ACU) of the vehicle. The vehicular service parameter data can be analyzed, as will be shown in more detail in FIGS. 6 and 7. Further, the vehicular service parameter data can be delivered, e.g., to the vehicular service provider and/or the vehicular service customer. Correspondingly, at 312, the vehicular service parameter data is transmitted from the vehicle communication terminal 115 with which the parameter monitoring unit 230 is in communication to the vehicular service provider terminal 105 and/or the vehicular service customer terminal 110.

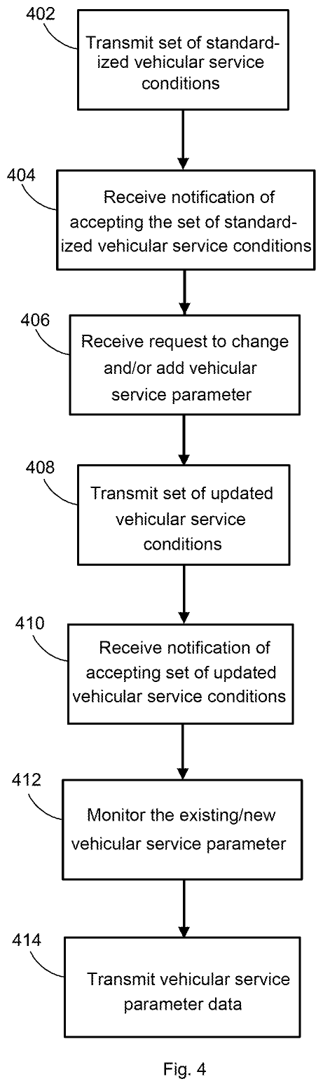

FIG. 4 illustrates exemplary operations that may be performed by the system, and in a particular example, by the vehicular service provider terminals 105, e.g., the OEM servers, the component supplier servers or the mobility service provider servers. In various embodiments, at 402, the vehicular service provider terminal 105 transmits, through its I/O subsystem 210 and via the network 107, in particular the distributed database system 109 such as blockchain, a set of initial vehicular service conditions of the vehicular service provider to the vehicular service customer terminal 110. The vehicular service customer terminal 110 receives, through its I/O subsystem 210 and via the network 107, the set of initial vehicular service conditions which contain a plurality of vehicular service parameters.

The vehicular service customer may agree with the initial vehicular service conditions in its entirety. The vehicular service customer may then initiate sending a notification of acceptance to the vehicular service provider. At 404, the vehicular service provider terminal 105 receives, through its I/O subsystem 210 and via the network 107, the notification of accepting the set of initial vehicular service conditions from the vehicular service customer terminal 110. At this point, the provision of vehicular services according to the conditions agreed on may take place.

During usage of the provided vehicular services, the vehicular service customer may wish to change one or more aspects contained in the set of initial vehicular service conditions. In this case, the vehicular service customer may request to change an existing vehicular service parameter and/or to add a new vehicular service parameter into the vehicular service conditions. The vehicular service customer may then initiate sending the request to the vehicular service provider. At 406, the vehicular service provider terminal 110 receives, through its I/O subsystem 210 and via the network 107, the request of the vehicular service customer to change an existing vehicular service parameter and/or to add a new vehicular service parameter. At this point, the provision of vehicular services has already taken place. That is, the process of service adjustment starts after the service has begun to be carried out.

After receiving the change request from the vehicular service customer, the vehicular service provider may issue an updated version of vehicular service conditions which take into account the changed existing vehicular service parameter and/or the added new vehicular service parameter as requested by the vehicular service customer. At 408, the vehicular service provider terminal 105 transmits a set of updated vehicular service conditions to the vehicular service customer terminal 110.

The vehicular service customer terminal 110 receives the transmitted set of updated vehicular service conditions, so that the vehicular service customer is able to provide a notification of accepting the updated vehicular service conditions. At 308, the vehicular service provider terminal 105 receives the notification of accepting the updated vehicular service conditions from the vehicular service customer terminal 110.

After completion of step 410, both sides—the vehicular service provider and the vehicular service customer—have reached an agreement over the updated vehicular service conditions taking into account the changed existing vehicular service parameter and/or the added new vehicular service parameter as requested by the vehicular service customer. The provision and usage of the vehicular services with regard to the changed and/or added vehicular service parameter can be periodically or continuously monitored so as to ensure that such vehicular services are performed and utilized in a proper manner. Also, this measure can provide grounds and factual basis for possible financial settlement processes involving the vehicular service provider and the vehicular service customer.

For this purpose, at 412, the existing vehicular service parameter that has been changed and/or the new vehicular service parameter that has been added as requested by the vehicular service customer is monitored by the parameter monitoring unit 230 shown in FIG. 2. The data generated by this monitoring process (vehicular service parameter data) can be analyzed, as will be shown in more detail in FIGS. 6 and 7. Further, the vehicular service parameter data can be delivered, e.g., to the vehicular service provider and/or the vehicular service customer. Correspondingly, at 414, the vehicular service parameter data is transmitted from the vehicle communication terminal 115 with which the parameter monitoring unit 230 is in communication to the vehicular service provider terminal 105 and/or the vehicular service customer terminal 110.

In various embodiments, the request to change the existing vehicular service parameter and/or to add the new vehicular service parameter may originate from the vehicular service user that, for some cases, differ from the person of the vehicular service customer. For instance, the vehicular service customer may be the owner of the vehicle whereas the vehicular service user may be a child of the vehicular service customer. In such cases, a notification to change the existing vehicular service parameter and/or to add the new vehicular service parameter may first be transmitted by the vehicular service user terminal 125 (e.g. a mobile device such as smartphone containing an application software program (App) operable using a Human-Machine-Interface (HMI)) to the vehicular service customer terminal 105. The vehicular service customer then sends the request to the vehicular service provider, so that the vehicular service provider terminal 105 receives the request as described in steps 304 and 406 in FIGS. 3 and 4, respectively.

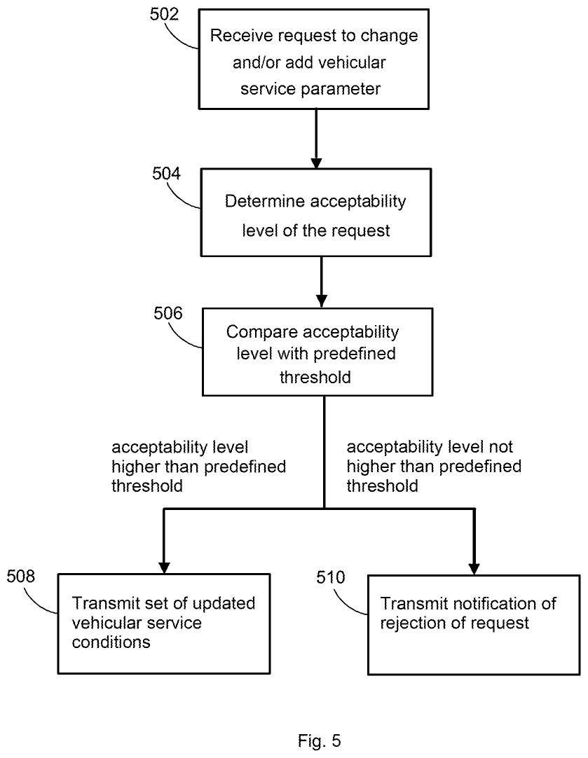

FIG. 5 illustrates exemplary operations that may be performed by the system, and in a particular example, by the vehicular service provider terminals 105, e.g., the OEM servers, the component supplier servers or the mobility service provider servers. At 502, the vehicular service provider terminal 110 receives, through its I/O subsystem 210 and via the network 107, the request of the vehicular service customer to change an existing vehicular service parameter and/or to add a new vehicular service parameter. This is the same step as 304 in the exemplary operations shown in FIGS. 3 and 406 in the exemplary operations shown in FIG. 4. In the cases shown in FIG. 3 and FIG. 4, step 304 and 406 are followed by step 306 and 408 as described above, respectively. In FIG. 5, on the other hand, step 502 is followed by several additional steps before step 508 which is the same step as 304 and 406 is performed.

At 504, an acceptability level of the request of the vehicular service customer is determined, e.g., by the CPU 215 of the vehicular service provider terminals 105. For this purpose, the request of the vehicular service customer is analyzed in detail. In particular, if the existing vehicular service parameter is requested to be changed from its current value as agreed on in the initial set of vehicular service conditions to a new value, the new value is examined with regard to its feasibility, safety, cost and/or implementation time based on one or more historical records contained e.g., in the memory 220 of the vehicular service provider terminals 105. The analysis delivers a quantitative result being the acceptability level which may be graded using a scale from 0% to 100%.

At 506, the determined acceptability level is compared with a predefined threshold. This may be performed e.g., by the CPU 215 of the vehicular service provider terminals 105. The predefined threshold may be stored in the memory 220 of the vehicular service provider terminals 105. The predefined threshold may be any value between 0% and 100%. For instance, the predefined threshold may be 50%, 60%, 70%, 80% or 90%.

If the determined acceptability level is higher than a predefined threshold, the process proceeds further to step 508 for transmitting the set of updated vehicular service conditions by the vehicular service provider terminal 105 to the vehicular service customer terminal 110. From this stage on, the exemplary method proceeds in accordance with FIGS. 3 and 4. If the determined acceptability level is not higher than a predefined threshold, the exemplary method proceeds with step 510, at which a notification of rejection of the request, which is issued by the vehicular service provider, is transmitted by the vehicular service provider terminal 105 to the vehicular service customer terminal 110. At this stage, the vehicular service customer may propose a second request and sends it to the vehicular service provider. With this, the exemplary method may return to step 502 and proceeds further as describe above, until the determined acceptability level is higher than the predefined threshold.

FIG. 6 illustrates exemplary operations that may be performed by the system, and in a particular example, by the vehicular service provider terminals 105, e.g., the OEM servers, the component supplier servers or the mobility service provider servers. At 602, the existing vehicular service parameter that has been changed and/or the new vehicular service parameter that has been added as requested by the vehicular service customer is monitored by the parameter monitoring unit 230 shown in FIG. 2. This is the same step as 310 and 412 shown in FIGS. 3 and 4. In the cases shown in FIG. 3 and FIG. 4, step 310 and 412 are followed by step 312 and 414 as described above, respectively. In FIG. 6, on the other hand, step 602 is followed by several additional steps before step 606, which is a specific form of steps 304 and 406, is conditionally performed.

At 604, the vehicular service parameter data is analyzed to determine whether it is in accordance with updated service conditions. This may be performed by, e.g., the monitoring unit 230 itself or the CPU 215 of the vehicle communication terminal 115. In various embodiments, the value of the existing vehicular service parameter may be requested by the vehicular service customer to be changed to a new value. In this case, the vehicular service parameter data generated by monitoring the existing vehicular service parameter is compared with the new value agreed on in the set of updated vehicular service conditions.

In various embodiments, if the vehicular service parameter data deviates from the new value by an amount that exceeds a predefined threshold, the entity that performs the analysis, e.g., the monitoring unit 230 itself or the CPU 215 of the vehicle communication terminal 115, may arrive at the conclusion that the vehicular service parameter data is not in accordance with the set of updated vehicular service conditions. In this case, at 608, the vehicle communication terminal 115 transmits the generated vehicular service parameter together with a notification of non-accordance to the vehicular service provider terminal 105 and/or the vehicular service customer terminal 110. In various embodiments, at 610, the vehicular service provider terminal 105 and/or the vehicular service customer terminal 110 may transmit the notification of non-accordance, preferably together with further information such as record of the vehicular service parameter data and/or the updated vehicular service conditions, to the financial settlement terminal 125.

In various embodiments, if the vehicular service parameter data does not deviate from the new value by an amount that exceeds a predefined threshold, the entity that performs the analysis, e.g., the monitoring unit 230 itself or the CPU 215 of the vehicle communication terminal 115, may arrive at the conclusion that the vehicular service parameter data is in accordance with the set of updated vehicular service conditions. In this case, at 606, the vehicle communication terminal 115 transmits the generated vehicular service parameter together with a notification of accordance to the vehicular service provider terminal 105 and/or the vehicular service customer terminal 110.

FIG. 7 illustrates exemplary operations that may be performed by the system, and in a particular example, by the vehicular service provider terminals 105, e.g., the OEM servers, the component supplier servers or the mobility service provider servers. At 702, the existing vehicular service parameter that has been changed and/or the new vehicular service parameter that has been added as requested by the vehicular service customer is monitored by the parameter monitoring unit 230 shown in FIG. 2. At 704, the vehicular service parameter data is transmitted from the vehicle communication terminal 115 with which the parameter monitoring unit 230 is in communication to the vehicular service provider terminal 105 and/or the vehicular service customer terminal 110. These two steps are the same steps as 310, 312 and 412, 414 respectively shown in FIGS. 3 and 4. In difference to the exemplary operations shown in FIG. 6, the determination whether the vehicular service parameter data is in accordance with the set of updated service conditions is performed, at 706, by the entity which receives the vehicular service parameter data from the vehicle communication terminal 115. In various embodiments, the determination is performed e.g., by the CPU 215 of the vehicular service provider terminal 105 and/or the vehicular service customer terminal 110.

In various embodiments, if the vehicular service parameter data deviates from the new value by an amount that exceeds a predefined threshold, the entity that performs the analysis, e.g., the CPU 215 of the vehicular service provider terminal 105 and/or the vehicular service customer terminal 110 may arrive at the conclusion that the vehicular service parameter data is not in accordance with the set of updated vehicular service conditions. In this case, at 708, the vehicular service provider terminal 105 and/or the vehicular service customer terminal 110 transmit the notification of non-accordance, preferably together with further information such as record of the vehicular service parameter data and/or the updated vehicular service conditions, to the financial settlement terminal 125.

In various embodiments, if the vehicular service parameter data does not deviate from the new value by an amount that exceeds a predefined threshold, the entity that performs the analysis, e.g., the CPU 215 of the vehicular service provider terminal 105 and/or the vehicular service customer terminal 110 may arrive at the conclusion that the vehicular service parameter data is in accordance with the set of updated vehicular service conditions. In this case, the method may terminates as indicated by “End” in FIG. 7.

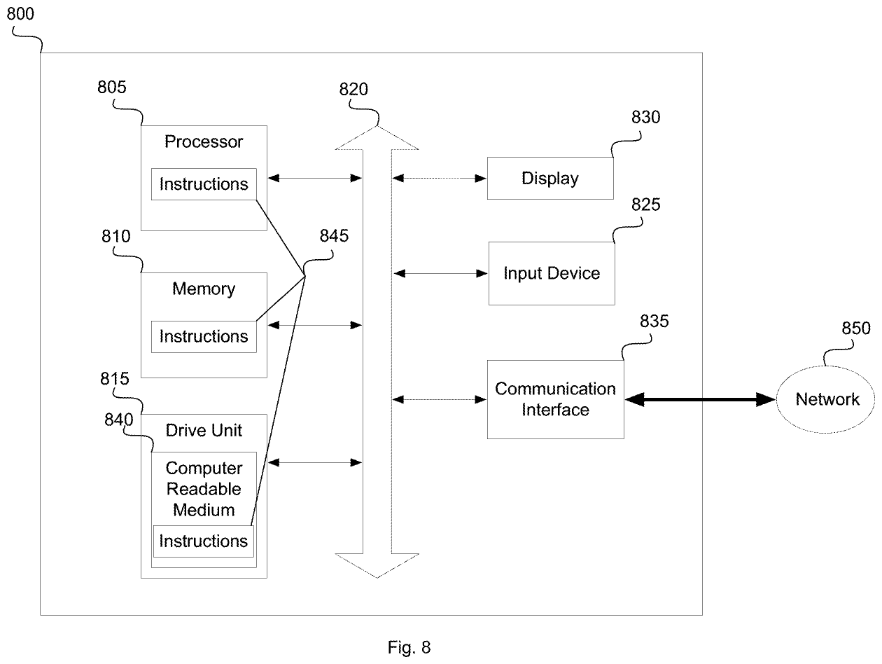

FIG. 8 illustrates a computer system 800 that may form part of or implement the terminals (105, 110, 115, 120, and/or 125) described above. The computer system 800 may include a set of instructions 845 that the processor 805 may execute to cause the computer system 800 to perform any of the operations or methods described above. The computer system 800 may operate as a stand-alone device or may be connected, e.g., using a network, to other computer systems or peripheral devices.

In a networked deployment, the computer system 800 may operate in the capacity of a server or as a client-user computer in a server-client user network environment, or as a peer computer system in a peer-to-peer (or distributed) network environment. The computer system 800 may also be implemented as or incorporated into various devices, such as a personal computer or a mobile device, capable of executing the instructions 845 (sequential or otherwise) that specify actions to be taken by that machine. Further, each of the systems described may include any collection of sub-systems that individually or jointly execute a set, or multiple sets, of instructions to perform one or more computer functions.

The computer system 800 may include one or more memory devices 810 on a bus 820 for communicating information. In addition, code or instructions operable to cause the computer system to perform any of the operations and/or methods described above may be stored in the memory 810. The memory 810 may be a random-access memory, read-only memory, programmable memory, hard disk drive or any other type of memory or storage device.

The computer system 800 may include a display 830, such as a liquid crystal display (LCD), a cathode ray tube (CRT), or any other display suitable for conveying information. The display 830 may act as an interface, in particular a Human Machine Interface (HMI), for the user to see the functioning of the processor 805, or specifically as an interface with the software stored in the memory 810 or in the drive unit 815.

Additionally, the computer system 800 may include an input device 825, such as a keyboard or mouse, configured to allow a user to interact with any of the components of system 800. Additionally, the input device 825 may comprise a scanner, such as a camera, an optical sensor, a laser, a RFID reader, or any other device capable of scanning and/or sensing an identifying mark or signal on a replacement part.

The computer system 800 may also include a disk or optical drive unit 815. The disk drive unit 815 may include a computer-readable medium 840 in which the instructions 845 may be stored. The instructions 845 may reside completely, or at least partially, within the memory 810 and/or within the processor 805 during execution by the computer system 800. The instructions 845, when executed by the processor 805, may cause the processor 805 to perform any of the operations and/or methods discussed herein. The memory 810 and the processor 805 also may include computer-readable media as discussed above.

The computer system 800 may include a communication interface 1235 to support communications via a network 850. The network 850 may include wired networks, wireless networks, or combinations thereof. The communication interface 1235 network may enable communications via any number of communication standards, such as 802.11, 802.12, 802.20, WiMAX, cellular telephone standards, Bluetooth, or other communication standards.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein may be employed.

The method and system may also be embedded in a non-transitory computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

While methods and systems have been described with reference to certain embodiments, it will be understood by those skilled in the art that various changes may be made, and equivalents may be substituted without departing from the scope of the claims. Many other modifications may be made to adapt a particular situation or material to the teachings without departing from its scope. Therefore, it is intended that the present methods and systems not be limited to the particular embodiment disclosed, but that the disclosed methods and systems include all embodiments falling within the scope of the appended claims.

We claim:

1. A method for communicating between a vehicular service provider terminal associated with a vehicular service provider, a vehicular service customer terminal associated with a vehicular service customer, and a vehicle communication terminal associated with a vehicle, the method comprising:
transmitting, by the vehicular service provider terminal and to the vehicular service customer terminal, a set of initial vehicular service conditions;
receiving, by the vehicular service provider terminal and from the vehicular service customer terminal, a request to change an existing vehicular service parameter and/or to add a new vehicular service parameter;
transmitting, by the vehicular service provider terminal and to the vehicular service customer terminal, a set of updated vehicular service conditions taking into account the changed or added vehicular service parameter;
receiving, by the vehicular service provider terminal and from the vehicular service customer terminal, a notification of accepting the set of updated vehicular service conditions by the vehicular service customer;
monitoring, by a parameter monitoring unit in communication with the vehicle communication terminal, the existing and/or new vehicular service parameter in order to generate vehicular service parameter data; and
transmitting, by the vehicle communication terminal and to the vehicular service provider terminal and/or the vehicular service customer terminal, the generated vehicular service parameter data.

2. The method of claim 1, further comprising:
determining, by the vehicular service provider terminal, an acceptability level of the received request.

3. The method of claim 2, further comprising:
comparing, by the vehicular service provider terminal, the determined acceptability level with a predefined threshold.

4. The method of the claim 3, wherein:
the set of updated vehicular service conditions is transmitted to the vehicular service customer terminal under the condition that the determined acceptability level of the request is higher than the predefined threshold; and
a notification of rejection of the request by the vehicular service provider is transmitted by the vehicular service provider terminal and to the vehicular service customer terminal when the determined acceptability level of the request is not higher than the predefined threshold.

5. The method of claim 1, further comprising:
receiving, by the vehicular service provider terminal and from the vehicular service customer terminal, a notification of accepting the set of initial vehicular service conditions by the vehicular service customer.

6. The method of claim 5, wherein:
the request is received by the vehicular service provider terminal after the latter has received the notification of accepting the set of initial vehicular service conditions.

7. The method of claim 1, wherein:
the existing vehicular service parameter is changed periodically; and
a corresponding period is contained in the request.

8. The method of claim 1, further comprising:
storing the set of vehicular service parameter data generated by monitoring the existing and/or additional vehicular service parameter in a storage medium of the vehicle, wherein the storage medium comprises an electronic control unit, ECU, in particular an airbag control unit, ACU, of the vehicle.

9. The method of claim 1, wherein:
at least one of the method steps is performed using a decentralized database system, in particular a blockchain system.

10. The method of claim 1, wherein:
the vehicle communication terminal comprises a human-machine-interface, HMI.

11. The method of claim 1, wherein:
the monitoring of the existing and/or new vehicular service parameter is continual or periodic.

12. The method of claim 1, further comprising:
transmitting, by a vehicular service user terminal associated with a vehicular service user and to the vehicular service customer terminal, a notification to change the existing vehicular service parameter and/or to add the new vehicular service parameter, wherein the request received by the vehicular service provider terminal and from the vehicular service customer terminal corresponds to the transmitted notification.

13. The method of claim 12, wherein:
the vehicular service user terminal comprises a mobile device.

14. The method of claim 1, wherein:
the vehicular service provider terminal and/or the vehicular service customer terminal comprises a mobile device.

15. The method of claim 1, wherein:
the vehicle communication terminal comprises a control-area-network, CAN, and/or a nearfield communication network, NFC-network. 16, The method of claim 1, further comprising:
determining, whether the generated vehicular service parameter data is in accordance with the updated service conditions;
transmitting, by the vehicular service provider terminal and/or the vehicular service customer terminal and to a financial settlement terminal associated with a financial settlement entity, a notification of non-accordance if the vehicular service parameter data is not in accordance with the updated service conditions.

17. A system for communicating between a vehicular service provider terminal associated with a vehicular service provider, a vehicular service customer terminal associated with a vehicular service customer, and a vehicle communication terminal associated with a vehicle, the system comprising:
instruction code storage; and
a processor in communication with the instruction code storage, wherein the instruction code storage stores instructions that, when executed by the processor, cause the processor to perform a method comprising:
transmitting, by the vehicular service provider terminal and to the vehicular service customer terminal, a set of initial vehicular service conditions;
receiving, by the vehicular service provider terminal and from the vehicular service customer terminal, a request to change an existing vehicular service parameter and/or to add a new vehicular service parameter;
transmitting, by the vehicular service provider terminal and to the vehicular service customer terminal, a set of updated vehicular service conditions taking into account the changed or added vehicular service parameter;
receiving, by the vehicular service provider terminal and from the vehicular service customer terminal, a notification of accepting the set of updated vehicular service conditions by the vehicular service customer;
monitoring, by a parameter monitoring unit in communication with the vehicle communication terminal, the existing and/or new vehicular service parameter in order to generate vehicular service parameter data; and
transmitting, by the vehicle communication terminal and to the vehicular service provider terminal and/or the vehicular service customer terminal, the generated vehicular service parameter data.
